(19) United States
(12) Patent Application Publication
(10) Pub. No.: US 2006/0066790 A1
(43) Pub. Date: Mar. 30, 2006

(54) Semitransmissive liquid crystal display panel

(75) Inventors: Shinichiro Tanaka, Tottori-Shi (JP); Tae Nakahara, Tottori-Shi (JP)

Correspondence Address: MCDERMOTT WILL & EMERY LLP, 600 13TH STREET, N.W., WASHINGTON, DC, 20005-3096, US

(73) Assignees: SANYO ELECTRIC CO., LTD.; TOTTORI SANYO ELECTRIC CO., LTD.

(21) Appl. No.: 11/237,814

(22) Filed: Sep. 29, 2005

(30) Foreign Application Priority Data
Sep. 30, 2004 (JP) 2004-289338

(51) Int. Cl. G02F 1/1337; G02F 1/1335

(52) U.S. Cl. 349/123; 349/114

(57) ABSTRACT

A semitransmissive liquid crystal display panel 10 has a first substrate 11 having, formed in each of the areas demarcated by signal lines and scan lines laid in a grid-like shape thereon, a reflective portion and a transmissive portion formed by a pixel electrode 15 having a slit 17, a second substrate 19 having formed thereon a color filter 21, a common electrode 22, and ridges 23 and 41, alignment films 24 laid over the first and second substrates 11 and 19 and processed for vertical alignment, and a liquid crystal layer 25 laid between the first and second substrates 11 and 19 and showing a negative dielectric constant anisotropy. When no electric field is applied to the liquid crystal layer 25, the liquid crystal molecules are vertically aligned, and, when an electric field is applied to the liquid crystal layer 25, the liquid crystal molecules are horizontally aligned and inclined in the directions restricted by the slit 17 and the ridges 23 and 41. The slit 17 is formed in a central portion of the pixel electrode in the transmissive portion, and the ridges 23 and 41 are formed at the periphery of the pixel electrode 15 and in a central portion of the reflective portion.

This application is based on Japanese Patent Application No. 2004-289338 filed on Sep. 30, 2004, the contents of which are hereby incorporated by reference.

### BACKGROUND OF THE INVENTION

1. Field of the Invention

The present invention relates to a semitransmissive liquid crystal display panel. More particularly, the present invention relates to a semitransmissive liquid crystal display panel of a multi-domain vertical alignment type.

2. Description of Related Art

Generally, liquid crystal display apparatuses offer the advantages of being slim, lightweight, and power-saving. In particular, TFT (thin-film transistor) liquid crystal display apparatuses are widely used in portable data terminals to large-screen television monitors. One type of liquid crystal display panel for use in liquid crystal display apparatuses is those of a VA (vertical alignment) type. VA-type liquid crystal display panels are widely known to offer fast response combined with a wide viewing angle.

FIG. 4A shows a section of a VA-type liquid crystal display panel. The VA-type liquid crystal display panel 60 has, sealed between two substrates 62 and 64, liquid crystal whose dielectric constant shows a negative anisotropy. On one substrate 62 is laid a pixel electrode 61. On the other substrate 64 is laid a common electrode 63. Over the substrates 62 and 64 are laid alignment films 66 and 67, respectively, which have both been processed for vertical alignment. Outside the substrates 62 and 64 are laid polarizer plates 68 and 69, respectively, which are laid in a cross-Nicol arrangement.

When no electric field is applied between the two electrodes 61 and 63, the liquid crystal molecules 65 between the substrates are vertically aligned. Thus, the linearly polarized light transmitted through one polarizer plate is then, as it is, transmitted through the liquid crystal layer, and is then intercepted by the other polarizer plate. This makes the liquid crystal display panel 60 appear dark, that is, black.

By contrast, when an electric field is applied between the two electrodes 61 and 63, as shown in FIG. 4B, the liquid crystal molecules 65 between the substrates are horizontally aligned. Thus, the linearly polarized light transmitted through one polarizer plate is then, through birefringence it undergoes when transmitted through the liquid crystal layer, formed into elliptically polarized light, which is then transmitted through the other polarizer plate. This makes the liquid crystal display panel 60 appear bright, that is, white.

In this VA-type liquid crystal display panel 60, when no electric field is applied between the two electrodes 61 and 63, all the liquid crystal molecules 65 are so aligned as to stand upright on the alignment films 66 and 67, vertically thereto. By contrast, when an electric field is applied between the two electrodes 61 and 63, it is not possible to control the orientations in which the individual liquid crystal molecules 65 are tilted in the horizontal direction.

Thus, left as they are, the liquid crystal molecules 65, when horizontally aligned, are tilted in random directions. Disadvantageously, this results in notably uneven display, and causes disclination due to disturbed alignment of liquid crystal molecules at the periphery of each pixel.

These disadvantages can be overcome in the following manner. When no electric field is applied between the electrodes 61 and 63, the liquid crystal molecules 65 are made to stand inclined at a slight angle (pre-tilt angle) to the vertical axis, with the inclination direction distributed similarly among the individual pixels. In this way, it is possible to restrict the direction in which the liquid crystal molecules 65 are tilted when a voltage is applied between the electrodes 61 and 63, and thereby to achieve even display.

Japanese Patent Application Laid-open No. H11-242225 and Japanese Patent Application Laid-open No. 2001-083517 disclose liquid crystal display panels of an MVA (multi-domain vertical alignment) type in which, when no electric field is applied between the electrodes, the liquid crystal molecules are inclined. In an MVA-type liquid crystal display panel, ridges and grooves are formed in pixels so that the inside of a single pixel is divided into a plurality of domains.

FIG. 5 is a plan view showing the pixel structure of the MVA-type liquid crystal display panel. FIG. 6 is a sectional view of FIG. 5 taken along line C-C. In the liquid crystal display panel 70, over a transparent first substrate 71 such as a glass plate, a gate insulating film 71′ is laid, and, on top thereof, scan lines 72 and signal lines 73 are laid in a grid-like pattern.

Each area enclosed by two adjacent scan lines 72 and two adjacent signal lines 73 corresponds to one pixel, and, within this area, a pixel electrode 74 is laid. At the intersection between a scan line 72 and a signal line 73, a TFT 75 as a switching device is formed, and is connected to the pixel electrode 74. Part of the pixel electrode 74 overlaps the adjacent scan line 72, with an insulating film 71″ laid in between. This overlap functions as an auxiliary capacitance. The pixel electrode 74 has a plurality of slits 76 (described later) formed therein. The pixel electrode 74 is covered with an alignment film 77 that has been processed for vertical alignment.

On the other hand, on a transparent second substrate 78 such as a glass substrate, a black matrix 79 is formed so as to demarcate the individual pixels, and in addition color filters 80 are laid one for each pixel. As the color filters 80, one of red (R), green (G), and blue (B) filters is laid to correspond to each pixel. Over the color filters 80 is laid a common electrode 81, which is a transparent electrode of, for example, ITO. On top of the common electrode 81, ridges 82 are formed in a predetermined pattern. The common electrode 81 and the ridges 82 are covered with an alignment film 83 that has been processed for vertical alignment.

Between the first and second substrates 71 and 78 is laid a liquid crystal layer 84 whose dielectric constant shows a negative anisotropy. When no electric field is present between the pixel electrode 74 and the common electrode 81, the liquid crystal molecules 84′ are vertically aligned by being restricted by the alignment films 77 and 83. When an electric field is present between the pixel electrode 74 and the common electrode 81, the liquid crystal molecules 84′ are inclined in the horizontal direction. Here, the liquid crystal molecules 84′ are inclined in predetermined directions by being restricted by the slits 76 and the ridges 82, producing a plurality of domains within a single pixel. It should be noted that FIG. 6 schematically shows a state in which an electric field is present between the pixel electrode 74 and the common electrode 81.

Outside the first substrate 71, a first polarizer plate 85 is laid. Outside the second substrate 78, a second polarizer plate 86 is laid. The first and second polarizer plates 85 and 86 are so set that their transmission axes are perpendicular to each other. The orientations of the first and second polarizer plates 85 and 86 are set according to the relationship between their transmission axes and the orientations in which the liquid crystal molecules 84′ are inclined. The relationship between the transmission axes of the first and second polarizer plates 85 and 86 and the directions in which the liquid crystal molecules 84′ are inclined will be discussed in detail later. Here, for the sake of simplicity, it is assumed that the transmission axis of the first polarizer plate 85 runs in the same direction in which the scan lines 72 extend, and the transmission axis of the second polarizer plate 86 runs in the same direction in which the signal lines 73 extend.

When no electric field is present between the pixel electrode 74 and the common electrode 81, the liquid crystal molecules 84′ are vertically aligned. Thus, the linearly polarized light transmitted through the first polarizer plate 85 is then, while remaining linearly polarized light, transmitted through the liquid crystal layer 84, and is then intercepted by the second polarizer plate 86, resulting in black display. By contrast, when a predetermined voltage is applied to the pixel electrode 74 and thus an electric field is present between the pixel electrode 74 and the common electrode 81, the liquid crystal molecules 84′ are inclined in the horizontal direction. Thus, the linearly polarized light transmitted through the first polarizer plate 85 is then, when transmitted through the liquid crystal layer 84, formed into elliptically polarized light, and is then transmitted through the second polarizer plate 86, resulting in white display.

Next, the shapes of the slits 76 and the ridges 82 will be described. The slits 76 are formed by removing parts of the pixel electrode 74 by photolithography or the like. The ridges 82 is formed, for example, by laying a resist layer of acrylic resin or the like and then forming it into a predetermined pattern by photolithography.

The ridges 82 are formed in zigzags to run across a plurality of pixels, and the straight parts of the ridges 82 extend in directions at 45° to the signal lines 73, as viewed from a direction normal to the second substrate 78. In each pixel, in a substantially central part thereof, a ridge 82a running from the pixel adjacent on one side thereof bends at 90° and then runs back to the pixel adjacent on the same side. Moreover, in each pixel, near two corners, other ridges 82b running from the pixel adjacent on the other side run parallel to the straight parts of the perpendicularly bending ridge 82a.

The slits 76 are formed to run along the mid lines between two adjacent ridges 82. In the example currently discussed, as shown in FIG. 5, each pixel electrode 74 has three silts 76 formed therein; specifically two slits 76a are formed between the ridges 82a and 82b, and another slit 76b is formed between the ridge 82a and an edge of the pixel electrode 74.

The center lines of the slits 76a are parallel to the adjacent ridges 82, and thus run in directions inclined at 45° to the signal lines 73. The center lines of the slits 76a thus corresponds to the directions in which the slits 76a extend. Likewise, the slit 76b extend parallel to the adjacent ridge 82a. The direction in which the ridge 82a adjacent to the slit 76b extends bends perpendicularly within the pixel, and thus the direction in which the slit 76b extends bends within the pixel.

The liquid crystal molecules 84′ are aligned in orientations at 90° to the ridges 82 and the slits 76, as viewed from a direction normal to the first and second substrates 71 and 78. Moreover, with respect to a direction normal to the first and second substrates 71 and 78, the liquid crystal molecules 84′ are inclined in opposite directions between on opposite sides of the ridges 82 and the slits 76.

Outside the first and second substrates 71 and 78 are laid a first and a second polarizer plate 85 and 86, respectively. As seen from a direction normal to the first and second substrates 71 and 78, the angles between the transmission axes of the first and second polarizer plates 85 and 86 and the directions of the ridges 82 are set at 45°.

Thus, the angles between the inclined liquid crystal molecules 84′ and the transmission axes of the first and second polarizer plates 85 and 86 are 45°. When the angles between the inclined liquid crystal molecules 84′ and the transmission axes of the first and second polarizer plates 85 and 86 are 45°, light is transmitted through the first and second polarizer plates 85 and 86 most efficiently.

In the MVA-type liquid crystal display panel 70 described above, advantageously, the alignment films do not need to be processed by rubbing, and alignment division can be achieved by the laying of linear structures (76 and 82). This makes it possible to obtain a wide viewing angle combined with high contrast. Moreover, since there is no need to perform rubbing, the liquid crystal display panel 70 is easy to fabricate. In addition, there is no possibility of contamination with shavings of alignment films during rubbing.

The MVA-type liquid crystal display panel 70 described above, however, has the following disadvantages. The liquid crystal molecules are, in reality, not inclined in an ideal manner, making it impossible to achieve optimum display. In particular, at the periphery of the pixel electrode 74, the liquid crystal molecules 84′ are inclined not only by being restricted by the ridges 82 and the slits 76 but also by being influenced by the edge of the pixel electrode 74, often resulting in uneven display and the like.

FIG. 7 is a plan view schematically showing how the liquid crystal molecules 84′ are inclined. Arrows inside the pixel electrode 74 indicate the directions in which the liquid crystal molecules 84′ are inclined. The orientations of those arrows indicate the orientations of the liquid crystal molecules, when inclined, from their ends closer to the second substrate 78 having the ridges 82 to their ends closer to the first substrate 71 having the pixel electrode 74.

The orientations of the liquid crystal molecules 84′ are so restricted as to be inclined at about 90° to the ridges 82 and the slits 76. Moreover, the liquid crystal molecules 84′ are inclined in opposite directions between on opposite sides of the slits 76 and the ridges 82 near their outlines. Thus, the liquid crystal molecules 84′ are inclined in the same directions near the outlines of mutually adjacent ridges 82 and slits 76.

At the edge of the pixel electrode 74, the liquid crystal molecules 84′ are so influenced as to be inclined in directions at 90° to the edge. Since the edge of the pixel electrode 74 is not parallel to the slits 76 or the ridges 82, it adversely influences the inclination of the liquid crystal molecules 84′. This influence at the edge varies greatly according to how the slits 76 and the ridges 82 are located near the edge.

For example, in regions A1 shown in FIG. 7, the orientations of arrows near the slits 76 and the ridges 82 are about 45° deviated from the orientations of arrows near the edge. By contrast, in regions A2, the orientations of arrows near the slits 76 and the ridges 82 are about 135° deviated from the orientations of arrows near the edge. Thus, the inclination of the liquid crystal molecules 84′ is more disturbed in the regions A2, making uneven display more likely in the regions A2 than in the regions A1.

As described above, in the conventional MVA-type liquid crystal display panel 70, at an end of each pixel, the alignment of the liquid crystal molecules 84′ is disturbed by the edge of the pixel electrode 74. This results in the problem of disclination occurring at the periphery of the pixel.

With a view to overcoming this problem unique to an MVA-type liquid crystal display panel, namely the appearance of misaligned regions, Japanese Patent Application Laid-open No. 2001-083517 mentioned previously discloses another structure. FIG. 8 is a plan view showing a pixel of a so structured liquid crystal display panel. FIGS. 9A and 9B are sectional views of FIG. 8 taken along line D-D. While FIG. 9A shows a state observed when no electric field is applied, FIG. 9B shows a state observed when an electric field is applied. In FIGS. 8, 9A, and 9B, such parts as are found also in the liquid crystal display panel 70 shown in FIGS. 5 and 6 are identified with common reference numerals.

In the liquid crystal display panel 90, auxiliary ridges 89 are additionally laid outside the effective pixel area so as to be contiguous with the ridges 82 for controlling the alignment of the liquid crystal molecules 84′. In other respects, the structure here is substantially the same as that of the liquid crystal display panel 70 shown in FIGS. 5 and 6. In this MVA-type liquid crystal display panel 90, the liquid crystal molecules 84′ are less influenced by the edge of the pixel electrode 74 or by the electric fields from the adjacent pixels. Thus, it is possible to effectively alleviate disclination.

In portable appliances employing liquid crystal display panels, research and development have been done on liquid crystal display panels. A semitransmissive liquid crystal display panel offers advantages of both a transmissive one and a reflective one, and using it helps reduce power consumption. The above-described technique of MVA has also been applied to such semitransmissive liquid crystal display panels.

Japanese Patent Application Laid-open No. 2004-069767 discloses an MVA-type semitransmissive liquid crystal display panel. In this liquid crystal display panel, slits are provided in the common electrode of both a reflective portion and a transmissive portion on the color filter side, and open regions or elevating members are provided, as an aligning means for dividing the alignment of liquid crystal molecules, near the pixel electrode of the reflective portion and the pixel electrode of the transmissive portion.

In small-screen liquid crystal display panels used in the display section of mobile appliances such as digital cameras and cellular phones, very high resolutions have recently come to be sought-after. For example, nowadays, for about 2.2-inch screens, 320×240-pixel (QVGA) liquid crystal display panels are widely used. In addition, development are being done on 640×480-pixel (VGA) liquid crystal display panels for about 2.2-inch screens, hence with resolutions of 300 ppi and over.

In such small-screen, high-resolution liquid crystal display panels, compared with liquid crystal display panels or the like for, for example, 40-inch-screen television monitors, the size of one pixel is very small. A pixel typically has an auxiliary capacitance formed therein for the purpose of holding a voltage after an active device has turned off. Disadvantageously, as the size of a pixel becomes smaller, it becomes increasingly difficult to secure a sufficient capacitance as an auxiliary capacitance.

Liquid crystal display panels designed for mobile appliances are supposed to be used both outdoors and indoors. For this reason, for such application are often used semitransmissive liquid crystal display panels, which offer advantages of both transmissive and reflective ones, promising higher brightness like the former and permitting power saving like the latter. In a semitransmissive liquid crystal display panel, a reflective portion and a transmissive portion are provided within one pixel. It is therefore necessary, when the above-described technique of MVA is adopted, to form ridges and slits for restricting the alignment of liquid crystal molecules while giving consideration to their influence on display. Disadvantageously, this often makes it difficult to lay such ridges and slits.

### SUMMARY OF THE INVENTION

An object of the present invention is to provide an MVA-type semitransmissive liquid crystal display panel that permits a sufficient capacitance to be secured as an auxiliary capacitance and that offers satisfactory display quality.

To achieve the above object, according to the present invention, a semitransmissive liquid crystal display panel is provided with: first and second substrates that are disposed to face each other, the first substrate having signal lines and scan lines laid thereon in a grid-like pattern so as to demarcate pixels within each of which a reflective portion and a transmissive portion are formed; a liquid crystal layer that is laid between the first and second substrates and whose dielectric constant shows a negative anisotropy; alignment films that are laid over the first and second substrates, respectively, and that have been processed for vertical alignment; and an alignment restricter that is laid on at least one of the first and second substrates, the alignment restricter restricting the directions in which liquid crystal molecules are inclined. Here, the liquid crystal molecules are vertically aligned when no electric field is applied to the liquid crystal layer, and are horizontally aligned and inclined in the directions restricted by the alignment restricter when an electric field is applied to the liquid crystal layer. Furthermore, in this liquid crystal display panel, by the use of an auxiliary capacitance electrode, an auxiliary capacitance is formed on the first substrate in the reflective portion thereof, and the alignment restricter is formed on the second substrate in the reflective portion thereof and on the first substrate in the transmissive portion thereof.

With this structure, even in an MVA-type semitransmissive liquid crystal display panel, it is possible to secure an auxiliary capacitance electrode in such a way that it occupies the greater part of the reflective portion, and thereby to secure a sufficient auxiliary capacitance. Moreover, it is possible, while securing a high auxiliary capacitance in the reflective portion, to restrict the alignment of liquid crystal molecules also in the reflective portion. Furthermore, it is possible to alleviate disclination resulting from different alignments of liquid crystal molecules acting against each other near the boundary between the transmissive and reflective portions. Thus, it is possible to realize an MVA-type semitransmissive liquid crystal display panel that offers satisfactory display quality.

### BRIEF DESCRIPTION OF THE DRAWINGS

FIG. 1 is a plan view schematically showing one pixel of a semitransmissive liquid crystal display panel embodying the invention, as viewed through a color filter;

FIG. 2 is a sectional view along line A-A shown in FIG. 1;

FIGS. 3A to 3G are plan views schematically showing one pixel of other semitransmissive liquid crystal display panels embodying the invention, as viewed through a color filter;

FIGS. 4A and 4B are sectional views showing a conventional VA-type liquid crystal display apparatus;

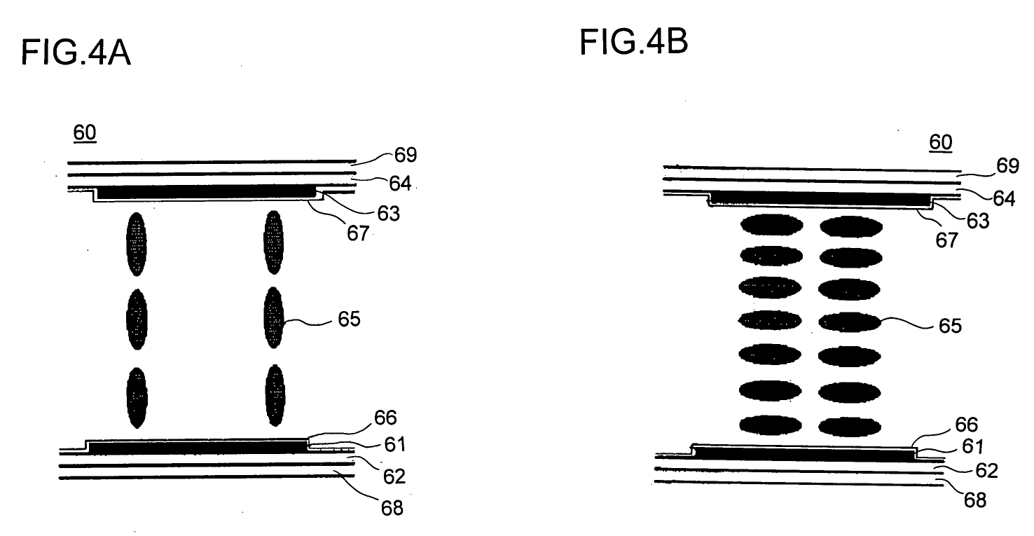

FIG. 5 is a plan view showing one pixel of a conventional MVA-type liquid crystal display panel;

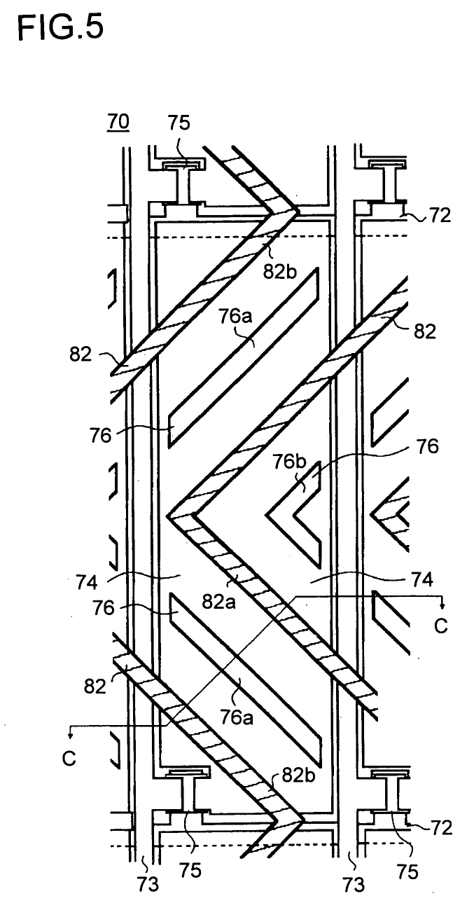

FIG. 6 is a sectional view along line C-C shown in FIG. 5;

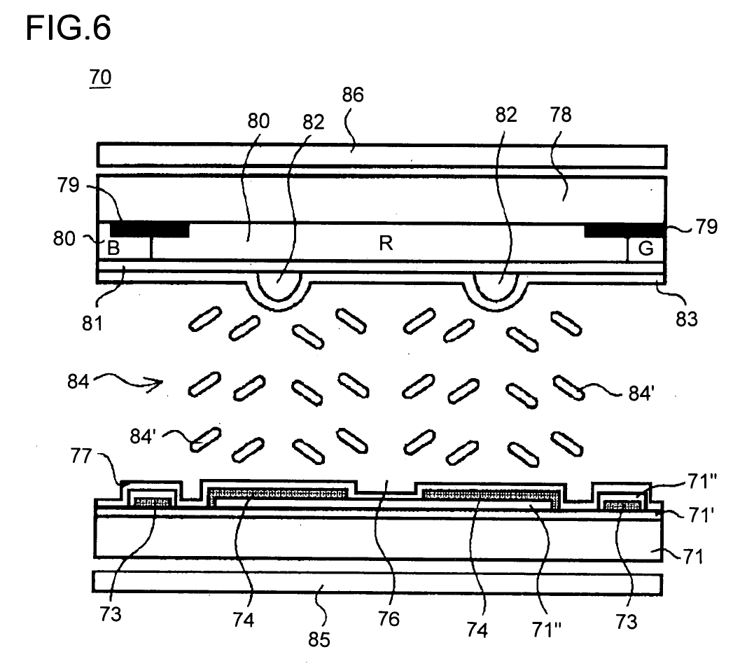

FIG. 7 is a diagram schematically showing how liquid crystal molecules are inclined in a conventional MVA-type liquid crystal display panel;

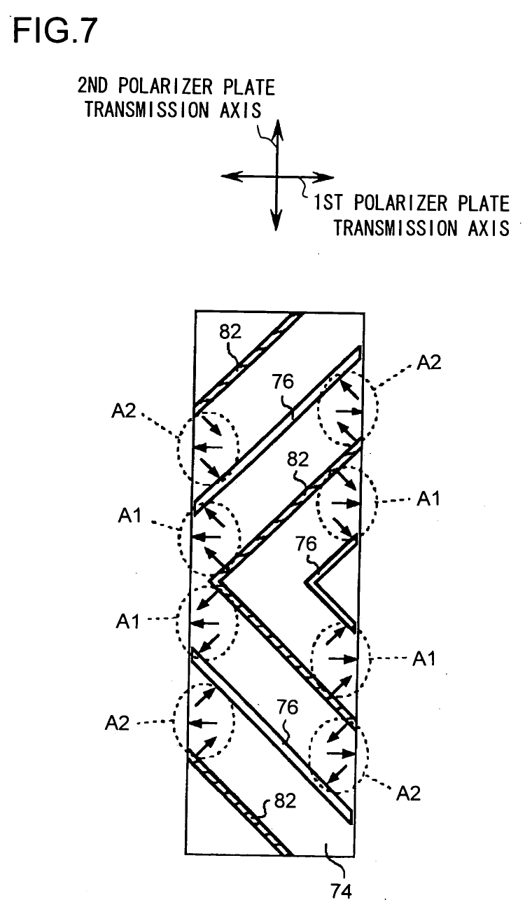

FIG. 8 is a plan view showing one pixel of another conventional MVA-type liquid crystal display panel; and

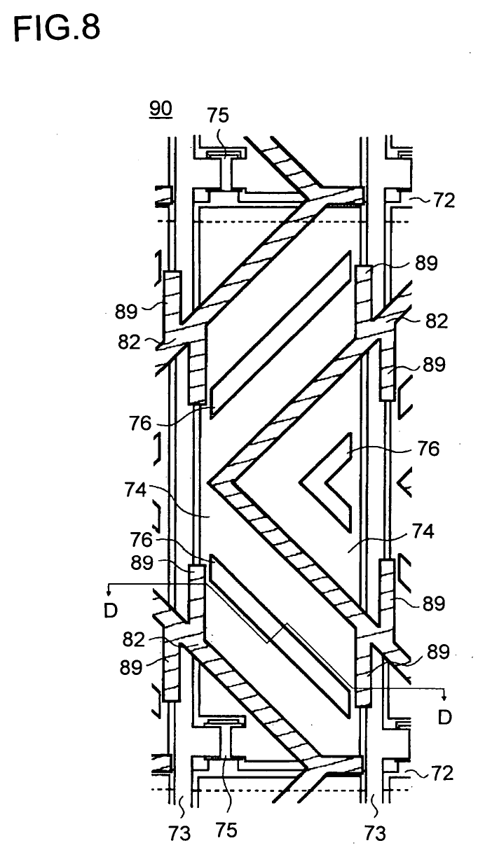

FIGS. 9A and 9B are sectional views along line D-D shown in FIG. 8.

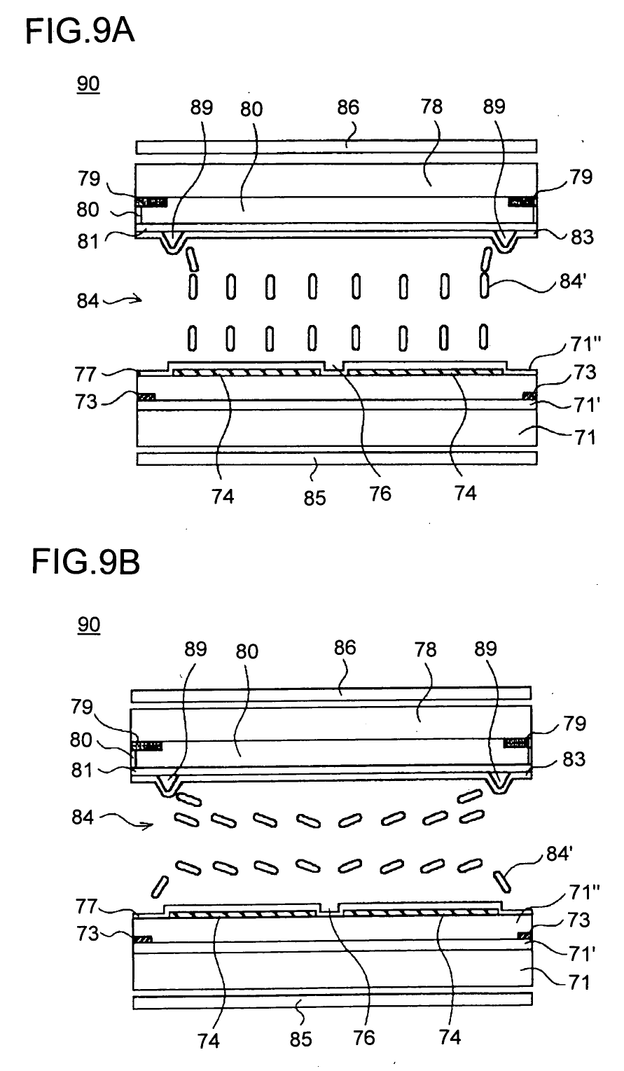

### DETAILED DESCRIPTION OF PREFERRED EMBODIMENTS

Hereinafter, embodiments of the present invention will be described with reference to the drawings. The following description deals with semitransmissive liquid crystal display panels as embodiments to which the technical idea of the present invention is applied. It should however be understood that the present invention may be practiced in any manner other than specifically described below. The embodiments described below are directed to small-screen liquid crystal display panels for use in the display section of mobile appliances such as digital cameras and cellular phones, and in particular to those for about 2.2-inch screens with 640×480 pixels (VGA), hence with resolutions of 300 ppi and over, and with 320×240 pixels (QVGA). Accordingly, in these liquid crystal display panels, the size of one pixel is far smaller than in liquid crystal display panels or the like for, for example, 40-inch-screen television monitors.

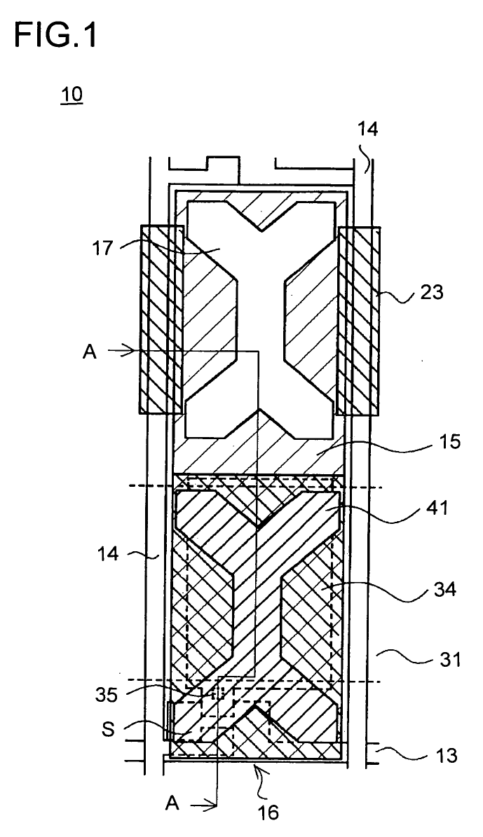

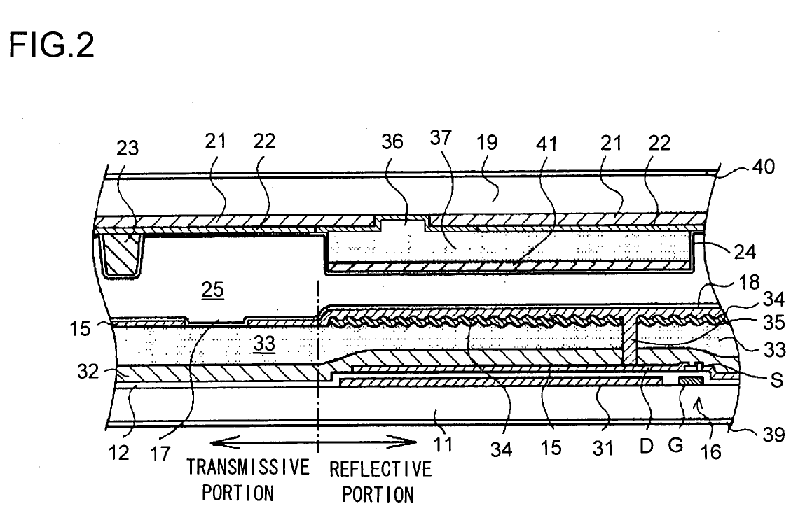

FIG. 1 is a plan view schematically showing the part corresponding to one pixel of a semitransmissive liquid crystal display panel embodying the invention, as viewed through a color filter. FIG. 2 is a sectional view along line A-A shown in FIG. 1.

In the semitransmissive liquid crystal display panel 10, over a transparent first substrate 11 such as a glass substrate, a gate insulating film 12 is laid, and, on top thereof, scan lines 13 and signal lines 14 are laid in a grid-like pattern. Each area enclosed by two adjacent scan lines 13 and two adjacent signal lines 14 corresponds to one pixel, and, within this area, a pixel electrode 15 is laid. This pixel is divided, at the middle thereof, into a reflective portion and a transmissive portion.

In a central portion of the pixel electrode 15 in the transmissive portion, a slit 17 (described in detail later) is formed. At the intersection between a scan line 13 and a signal line 14, a TFT 16 as switching device is formed, and is connected to the pixel electrode 15. Almost all over the reflective portion, an auxiliary capacity electrode 31 is laid on top of the first substrate 11.

The gate electrode G of the TFT 16 is connected to the scan line 13. The source electrode S of the TFT 16 is connected to the signal line 14. The drain electrode D of the TFT 16 is laid above the auxiliary capacity electrode 31, with a gate insulating film 12 laid in between. The auxiliary capacity electrode 31 is so secured as to occupy a large area almost all over the reflective portion, and accordingly the drain electrode D is so secured as to occupy a large area. In this way, it is possible to secure a high auxiliary capacity within one pixel.

Almost all over the surface of the TFT 16 and the surface of the gate insulating film 12, an insulating film 32 and an interlayer insulating film 33, both transparent, are laid. Any level differences on the surface of the interlayer insulating film 33 are removed to obtain a constant cell gap, and thus the surface of the interlayer insulating film 33 is formed flat. Slight surface irregularities, however, are left on the surface of the interlayer insulating film 33 in the reflective portion. This helps eliminate directivity and disperse the reflected light.

Over the surface of the interlayer insulating film 33 in the reflective portion is laid a reflective electrode 34 of a highly reflective metal such as silver or aluminum. On the surface of the reflective electrode 34 and on the surface of the interlayer insulating film 33 in the transmissive portion is laid a pixel electrode 15 of a transparent electrically conductive material such as ITO. The surface of the pixel electrode 15 and the slit 17 are covered with an alignment film 18 that has been processed for vertical alignment. The pixel electrode 15 in the reflective portion and the drain electrode D of the TFT 16 are electrically connected together by a contact hole 35.

On the other hand, on a transparent second substrate 19 such as a glass substrate, a black matrix (unillustrated) is formed so as to demarcate the individual pixels. Moreover, on the second substrate 19, color filters 21 are laid so that one of red (R), green (G), and blue (B) filters corresponds to each pixel.

The color filter 21 is so formed as to have the same thickness in the reflective and transmissive portions. Part of the color filter 21 is cut out to leave a cut-out portion 36. In the reflective portion, the light incident thereon passes through the color filter 21 twice, namely at the time of incidence and at the time of emergence. Thus, leaving the cut-out portion 36 helps make the reflective portion appear the same color as the transmissive portion.

On the color filter 21 is laid a common electrode 22, which is a transparent electrode of, for example, ITO. On the common electrode 22, ridges 23 are formed in a predetermined pattern. Moreover, all over the reflective portion, on the color filters 21, a top coat 37 is laid with a predetermined thickness. On the top coat 37, a ridge 41 is formed in a predetermined pattern. The common electrode 22 and the ridges 23 and 41 are covered with an alignment film 24 that has been processed for vertical alignment.

Between the first and second substrates 11 and 19 is laid a liquid crystal layer 25 whose dielectric constant shows a negative anisotropy. When no electric field is present between the pixel electrode 15 and the common electrode 22, the liquid crystal molecules are vertically aligned by being restricted by the alignment films 18 and 24. When an electric field is present between the pixel electrode 15 and the common electrode 22, the liquid crystal molecules are inclined in the horizontal direction. Here, the liquid crystal molecules are inclined in predetermined directions by being restricted by the slit 17 and the ridges 23, producing a plurality of domains within a single pixel. Outside the first and second substrates 11 and 19 are laid λ/4 phase difference plates 39 and 40, respectively.

Next, the shapes of the slit 17 and the ridges 23 will be described. The slit 17 is formed by removing part of the pixel electrode 15 by photolithography or the like. The ridges 23 are formed, for example, by laying a resist layer of acrylic resin or the like and then forming it into a predetermined pattern by photolithography. In this embodiment, the ridges 23 are formed one on each side of the rectangular transmissive portion so as to extend in the direction in which the pixel electrode 15 extends, the two ridges 23 thus located side by side above the signal lines 14.

The slit 17 is formed in a central portion of the pixel electrode 15 in the transmissive portion so as to be located between the ridges 23. In this embodiment, the slit 17 is formed in the shape of a thick erect Y and a thick inverted Y combined together so as to be symmetric about a horizontal middle line. The ridge 41 in the reflective portion is formed, like the slit 17 in the transmissive portion, in the shape of a thick erect Y and a thick inverted Y combined together so as to be symmetric about a horizontal middle line.

In the semitransmissive liquid crystal display panel 10 structured as described above, substantially no ridge exists in a central portion of the transmissive portion facing the pixel electrode 15. Thus, no part of the light transmitted through the pixel electrode 15 in the transmissive portion is absorbed by a ridge. Moreover, the liquid crystal molecules are inclined in directions perpendicular to the ridges 23 and the slit 17 with respect to a direction normal to the semitransmissive liquid crystal display panel 10.

Here, the liquid crystal molecules are so inclined as to point from the ridges 23 of the second substrate 19 to the slit 17 of the first substrate 11. Thus, at ends of the pixel where the ridges 23 and the slit 17 cross each other, the deviation of the orientations of the liquid crystal molecules is as small as, for example, 45°. Thus, it is possible to alleviate disclination, thereby to make display and brightness less uneven, and to obtain satisfactory display quality in the transmissive portion.

On the other hand, in the reflective portion, almost all the area thereof is occupied by the drain electrode D. Since the drain electrode D and the pixel electrode 15 are at the same potential, even if a slit is formed in the pixel electrode 15, it cannot restrict alignment because of the influence of the drain electrode D. Thus, when the ridge 41 is formed on the common electrode 22, the liquid crystal molecule can be aligned in predetermined directions.

Here, since the ridge 41 is formed in a central portion of the reflective portion, the liquid crystal molecules are so inclined as to point from the ridge 41 of the second substrate 78 to the ends of the pixel of the first substrate 71. In this way, even in the reflective portion, providing an alignment restricting means makes it possible to realize the feature of MVA.

Moreover, no member that would disturb the alignment of liquid crystal molecules exits between the reflective and transmissive portions, and the alignment continuously changes between the reflective and transmissive portions. This makes it possible to realize an MVA-type semitransmissive liquid crystal display panel that operates with reduced disclination and thus with less uneven display and brightness and that offers satisfactory display quality. From the viewpoint of preventing a lowering of brightness, it is preferable to make the ridges 23 so wide that the width of the signal lines 14 falls within the width of the ridges 23 and that, as seen in a plan view, the ridges 23 do not much overhang from the signal lines 14.

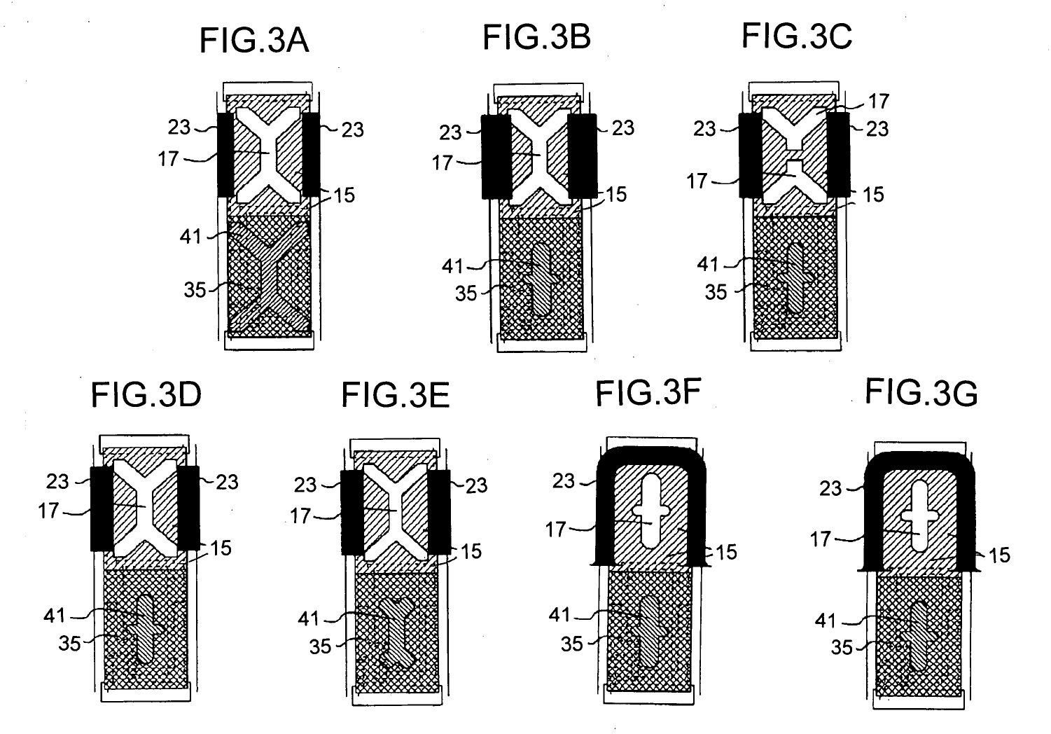

The shapes of the slit 17, of the ridges 23 in the transmissive portion, and of the ridge 41 in the transmissive portion are not limited to those shown in FIG. 1 as adopted in this embodiment, but may be modified in many ways. For example, in the liquid crystal display panel shown in FIG. 3A, the slit 17, the ridges 23, and the ridge 41 all have smaller widths than in the liquid crystal display panel shown in FIG. 1.

In the liquid crystal display panel shown in FIG. 3B, the slit 17 in the transmissive portion has a smaller width than in the liquid crystal display panel shown in FIG. 1. Moreover, the ridge 41 in the reflective portion is cross-shaped so as to be wide and long in the direction in which the pixel electrode 15 extends and narrow and short in the direction perpendicular thereto.

In the liquid crystal display panel shown in FIG. 3C, the slit 17 in the transmissive portion is divided into two parts each bifurcated at one end and thus substantially Y-shaped, with one part inverted relative to and separate from the other. These two parts are located symmetrically in the direction in which the pixel electrode 15 extends. Moreover, the ridge 41 in the reflective portion is cross-shaped so as to be long in the direction in which the pixel electrode 15 extends and short in the direction perpendicular thereto. The ridge 41 may have the same width in the two mutually perpendicular directions.

In the liquid crystal display panel shown in FIG. 3D, the slit 17 in the transmissive portion has a smaller width than in the liquid crystal display panel shown in FIG. 1. Moreover, the ridge 41 in the reflective portion is cross-shaped so as to be long in the direction in which the pixel electrode 15 extends and short in the direction perpendicular thereto. The ridge 41 may have the same width in the two mutually perpendicular directions.

In the liquid crystal display panel shown in FIG. 3E, the slit 17 in the transmissive portion has a smaller width than in the liquid crystal display panel shown in FIG. 3D. Moreover, the ridge 41 in the reflective portion is smaller than in the liquid crystal display panel shown in FIG. 3A.

In the liquid crystal display panels shown in FIGS. 3F and 3G, the slit 17 in the transmissive portion and the ridge 41 in the reflective portion are cross-shaped, with different widths and different lengths, so as to be long in the direction in which the pixel electrode 15 extends. The ridge 41 extending in the direction in which the pixel electrode 15 extends has a greater width in FIG. 3F than in FIG. 3G. Moreover, the ridge 23 in the transmissive portion is U-shaped so as to surround the transmissive portion except along the boundary between the reflective and transmissive portion.

In the semitransparent liquid crystal display panels shown in FIGS. 3A to 3G also, an alignment pattern similar to that conventionally achieved by MVA can be achieved in the reflective portion. Moreover, since no member that would disturb the alignment of liquid crystal molecules exits between the reflective and transmissive portions, the alignment continuously changes even between the reflective and transmissive portions. This makes it possible to realize a semitransmissive liquid crystal display panel that operates with reduced disclination and that offers satisfactory display quality.

### LIST OF REFERENCE NUMERALS

10 Liquid Crystal Display Panel
11 First Substrate
12 Gate Insulating Film
13 Scan Line
14 Signal Line
15 Pixel Electrode
16 TFT
17 Slit
19 Second Substrate
21 Color Filter
22 Common Electrode
23,41 Ridge
25 Liquid Crystal Layer
31 Auxiliary Capacity Electrode
33 Interlayer Insulating Film
34 Reflective Electrode
36 Cut-out Portion

what is claimed is:

1. A semitransmissive liquid crystal display panel comprising:
first and second substrates that are disposed to face each other, the first substrate having signal lines and scan lines laid thereon in a grid-like pattern so as to demarcate pixels within each of which a reflective portion and a transmissive portion are formed;
a liquid crystal layer that is laid between the first and second substrates and whose dielectric constant shows a negative anisotropy;
alignment films that are laid over the first and second substrates, respectively, and that have been processed for vertical alignment; and
an alignment restricter that is laid on at least one of the first and second substrates, the alignment restricter restricting a direction in which liquid crystal molecules are inclined,
the liquid crystal molecules being vertically aligned when no electric field is applied to the liquid crystal layer, and being horizontally aligned and inclined in a direction restricted by the alignment restricter when an electric field is applied to the liquid crystal layer,
wherein, by use of an auxiliary capacitance electrode, an auxiliary capacitance is formed on the first substrate in the reflective portion thereof, and
wherein the alignment restricter is formed on the second substrate in the reflective portion thereof and on the first substrate in the transmissive portion thereof.

2. The semitransmissive liquid crystal display panel of claim 1,
wherein the alignment restricter formed on the first substrate in the transmissive portion thereof is a slit formed in a central part of the transmissive portion.

3. The semitransmissive liquid crystal display panel of claim 1,
wherein the alignment restricter is a slit or ridge having at least one branched-off portion.

4. The semitransmissive liquid crystal display panel of claim 1,
wherein the alignment restricter formed in the transmissive portion is a slit formed in a pixel electrode on the first substrate, and a ridge is formed at a periphery of the transmissive portion so as to overlap the signal lines as seen in a plan view.

5. The semitransmissive liquid crystal display panel of claim 1, wherein the liquid crystal layer has different thicknesses in the reflective and transmissive portions.
